(19) United States
(12) Patent Application Publication
(10) Pub. No.: US 2008/0312460 A1
(43) Pub. Date: Dec. 18, 2008

(54) Multi-Frequency Ultrasonic Apparatus and Process for Producing Biofuels

(76) Inventor: J. Michael Goodson, Skillman, NJ (US)

Correspondence Address: STEPHEN M. EVERETT, 55 SECOND STREET, SUITE 1700, SAN FRANCISCO, CA, 94105, US

(21) Appl. No.: 12/136,747

(22) Filed: Jun. 10, 2008

Related U.S. Application Data
(60) Provisional application No. 60/966,545, filed on Jun. 13, 2007.

(51) Int. Cl. C11B 3/00; B01J 19/00

(52) U.S. Cl. 554/175; 422/129

(57) ABSTRACT

The present invention is an ultrasonic apparatus and process that utilizes multiple-frequency ultrasonic energy during production of biofuel. The ultrasonic apparatus includes a process tank containing a reactant fluid and at least two groups of ultrasonic transducers coupled to the process tank, wherein each group of transducers generates different frequencies. The process for transesterizing vegetable oils or fatty acids into fatty-acid alkyl esters includes steps of placing a reactant fluid including vegetable oils or fatty acids into the process tank, and applying ultrasonic energy to the reactant fluid in the tank at two separate frequencies in the range of 15 kHz to 1.5 MHz.

### FIELD OF THE INVENTION

This invention relates generally to processing apparatus and associated process methods involving the production of biodiesel or other biofuels, and relates more particularly to an improved process using dual frequency ultrasonic energy.

### BACKGROUND OF THE INVENTION

The present application claims the benefit of U.S. Provisional Patent Application 60/966,545, which was filed on Jun. 13, 2007, entitled “Multi-Frequency Ultrasonic Apparatus and Process for Producing Biofuels.”

It is known that the production of fatty acid alcohol esters for biodiesel or other biofuels benefits from the application of ultrasonic energy during the chemical reaction that produces the fatty acid alcohol esters and subsequent separation of fatty acid alcohol esters from glycerol. See, for example, U.S. Pat. No. 6,884,900, entitled “Method for Producing Fatty Acid Alcohol Ester.” This patent discloses arranging one or more ultrasonic transducers on a surface of a reactor or separation tank or coaxially inside the reactor or tank.

### SUMMARY OF THE INVENTION

The present invention is an ultrasonic apparatus and process that utilizes multiple-frequency ultrasonic energy during production of biofuel, generally, and more specifically, fatty acid alcohol ester. The process accelerates the transesterification of vegetable oils and/or fatty acids into fatty acid alkyl esters by applying multiple ultrasonic frequencies to the reactants during the transesterification process. The multiple frequencies are applied either sequentially or simultaneously. Testing has confirmed that applying multiple frequency ultrasonic energy, at frequencies of 58 kHz and 192 kHz and power of 5000 watts, produced an alkyl ester with a purity as high as 98% at a rate of 1 gallon per minute.

The process for the production of fatty acid alkyl ester comprises of the following steps: (1) providing an emulsion of vegetable oils or fatty acids, an alkaline catalyst, and an alkyl alcohol; (2) ultrasonically processing the emulsion with ultrasonic sources operating at multiple frequencies to accelerate the transesterification process; and (3) separating the transesterified emulsion into separate glycerol/glycerin and fatty acid alkyl ester phases.

The process for transesterizing vegetable oils or fatty acids into fatty-acid alkyl esters comprising at least the steps of placing a reactant fluid including vegetable oils or fatty acids into a tank, and applying ultrasonic energy to the reactant fluid in the tank at two separate frequencies in the range of 15 kHz to 1.5 MHz.

The process accelerates separation of the glycerol/glycerin and fatty acid alkyl ester phases produced in the transesterification process after the reactants have reached their final/equilibrium chemical state. The separation of the glycerol/glycerin involves separating the glycerol/glycerin from the fatty acid alkyl ester and unreacted chemical species in a phase separation step.

The apparatus includes a process tank with ultrasonic transducers of two or more frequencies mounted on or contained within the tank. One preferred embodiment includes a four- or five-sided tube with ultrasonic transducers of two frequencies mounted on the outside. The transducers are arranged in a pattern that alternates transducers of a lower frequency with transducers of a higher frequency so that the interior of the tank is exposed to both frequencies. Preferably, the frequencies are within the range of 15 kHz to 1.5 MHz. For example, one preferred embodiment has a first group of transducers with a first harmonic frequency of 58 kHz and a second group of transducers with a third harmonic frequency of 192 kHz. The 58 kHz transducers have a strong first harmonic vibration at 58 kHz and the 192 kHz transducers have a strong third harmonic vibration at 192 kHz. Both types of transducers have been enhanced by using ceramic components as disclosed in U.S. Pat. Nos. 5,748,566, 5,998,908, and 6,924,585 and U.S. application Ser. No. 10/936,104 (Publication 2005-0109368 A1), which are hereby incorporated by reference.

Alternatively, the multiple-frequency ultrasonic transducers may be push-pull transducers or immersible transducers located inside the tank or rod transducers located partially inside the tank and partially outside the tank.

A preferred embodiment of the process tank includes a tubular chamber that contains the reactants. The process tank can be operated as a continuous flow device, with reactants continuously entering one end of a flow-through tank and reaction products continuously exiting another end. Alternatively, the process tank can be operated in a batch process by filling it with reactants, transesterifying the reactants to form the reaction products while operating the multiple-frequency ultrasonic transducers, either simultaneously or sequentially, and then emptying the reaction products from the tank.

The processing apparatus includes at least a process tank having one or more walls with external surfaces and having an inlet and an outlet, wherein the tank defines an interior for containing a reactant fluid to be processed, and at least two groups of ultrasonic transducers coupled to the process tank, wherein each group of transducers has different harmonic frequencies, and wherein the groups of transducers are interspersed.

### BRIEF DESCRIPTION OF THE DRAWINGS

FIG. 1 is a perspective view of a reaction tank, according to the present invention, in the shape of a five-sided tube with ultrasonic transducers mounted on the outside surfaces.

FIG. 2 is a top view of the reaction tank of FIG. 1.

FIG. 3 is a sectional view of the reaction tank of FIG. 1 without transducers installed.

FIG. 4 is a perspective view of a cylindrical reaction tank, according to the present invention, with dual frequency push-pull transducers inside.

FIG. 5 is a sectional view of the reaction tank of FIG. 4.

FIG. 6 is a cut-away perspective view of the reaction tank of FIG. 4.

### DETAILED DESCRIPTION OF THE PREFERRED EMBODIMENTS

The drawings depict various preferred embodiments of the present invention for purposes of illustration only. One skilled in the art will readily recognize from the following discussion that alternative embodiments of the structures and methods illustrated herein may be employed without departing from the principles of the invention described herein.

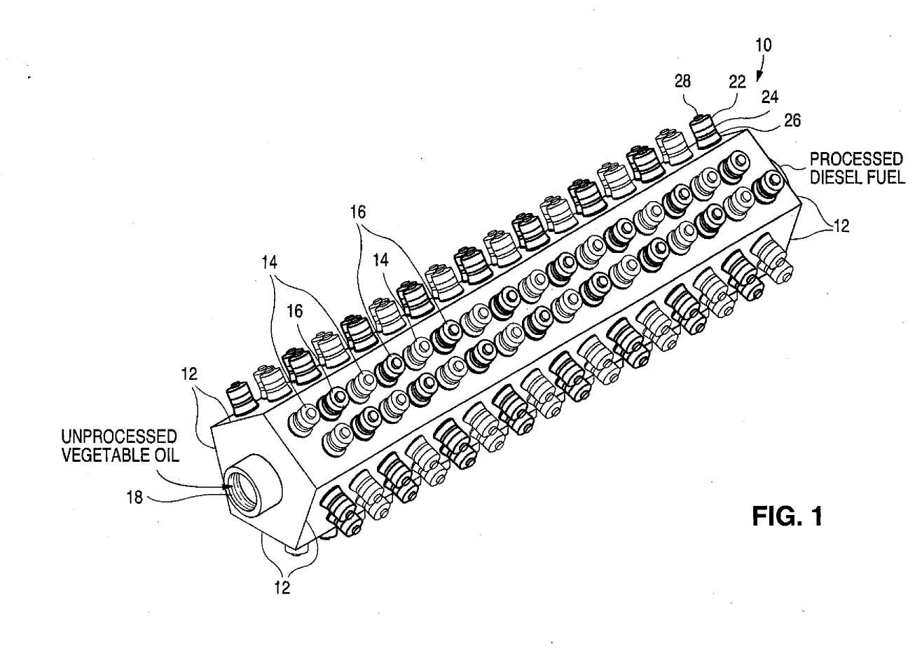

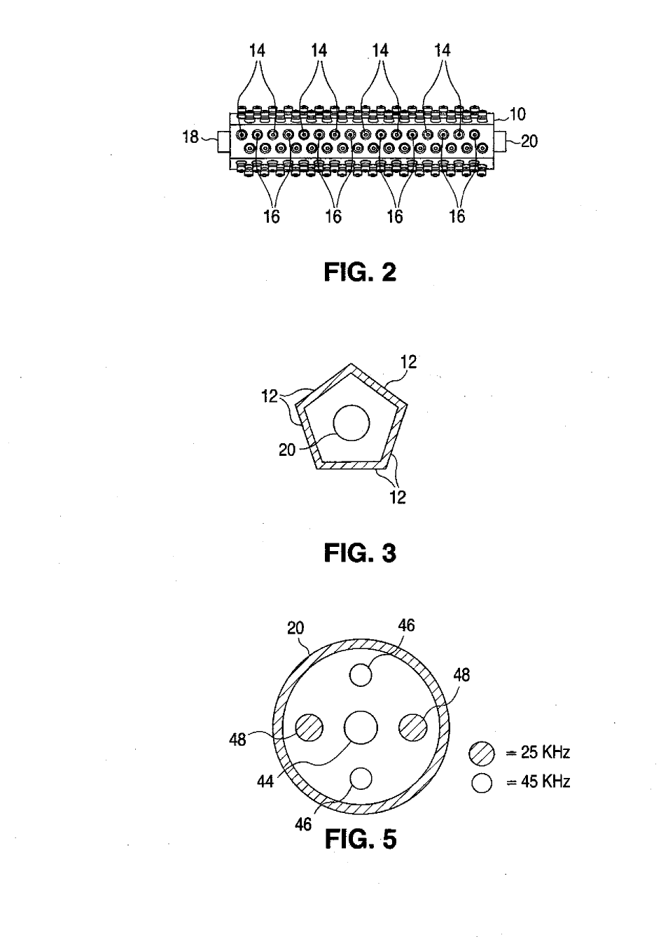

The present invention improves upon such prior processing apparatus by improving the way in which ultrasonic energy is supplied to the reactor or separation tank. In one embodiment of the present invention, shown in FIGS. 1-3, a process tank 10 is a tube with five flat side walls 12. Each side wall has an array of transducers 14, 16 mounted on it. Transducers 14 have a lower harmonic frequency than transducers 16. Each row of transducers has low frequency transducers 14 alternating with high frequency transducers 16. Preferably there are substantially equal numbers of both types of transducers and they are uniformly distributed along the walls 12 of the tank 10. The ultrasonic transducers are preferably piezoelectric transducers (PZTs) composed of piezoelectric crystals or piezoelectric ceramic, such as barium titanate or lead zirconate titanate. The transducers preferably have a stacked construction, including an end mass 22 at the top of the assembly, a piezoelectric layer 24, a non-piezoelectric ceramic resonator 25, and a head mass 26 at the bottom of the assembly, and held together with a compression bolt 28 at the central axis. The head mass of each transducer 14, 16 is attached to the surface of a wall 12. The transducers 14, 16 may be bonded to the tank with an epoxy polymer adhesive such as Supreme 10AOHT. This epoxy contains a ceramic filler of aluminum oxide (alumina). It is a heat curing epoxy with high shear strength and high peel strength. It also is thermally conductive and resistant to severe thermal cycling.

The tank 10 includes an inlet coupling 18 through which the reactants enter the tank. An outlet coupling 20 is at the opposite end of the tank through which the reaction products are removed from the tank. The side walls and end plates of tank 10 are preferably fabricated from 14 gauge stainless steel sheet metal. Other metals or non-metallic materials may also be used for the tank.

Each group of transducers 14, 16 is connected to an ultrasonic generator (not shown). The lower-frequency transducers 14 are connected to a generator that supplies an alternating-current driving signal at a fundamental frequency of the transducers 14. Similarly, the higher-frequency transducers 16 are connected to a generator (not shown) that supplies an alternating-current driving signal at a fundamental frequency of the transducers 16. Preferably the frequencies are in the range of 15 kHz to 1.5 MHz. For example, a lower frequency of 58 kHz (a first harmonic frequency) and a higher frequency of 192 kHz (a third harmonic frequency) may be used.

When alternating-current driving signals are supplied by the ultrasonic generators to the groups of transducers 14, 16, the transducers vibrate and transmit sonic waves into the walls 12 of the tank 10. The sonic waves transmit through the walls and into the reactants inside the tank and accelerate the transesterification and separation process within the tank.

The tank 10 need not have five side walls as illustrated and may have any shape that provides a closed vessel. For example, the tank could have three, four or six rectangular side walls, plus end plates. Also, the tank could be cylindrical, in which case the contact surfaces of the transducers would be radiused to match the outer radius of the tank. Or, the tank could be generally cylindrical with flat axial strips to provide flat mounting surfaces for the transducers. Other shape variations could be used so long as they allow for interspersed groups of transducers to be mounted and provide a closed vessel for containing the reactants and reaction products.

Another alternative to the above-described process tank is to have more than two groups of transducers. For example, the transducers associated with the process tank could include a low-frequency group, a middle-frequency group, and a high-frequency group, with transducers from each group uniformly distributed over the tank.

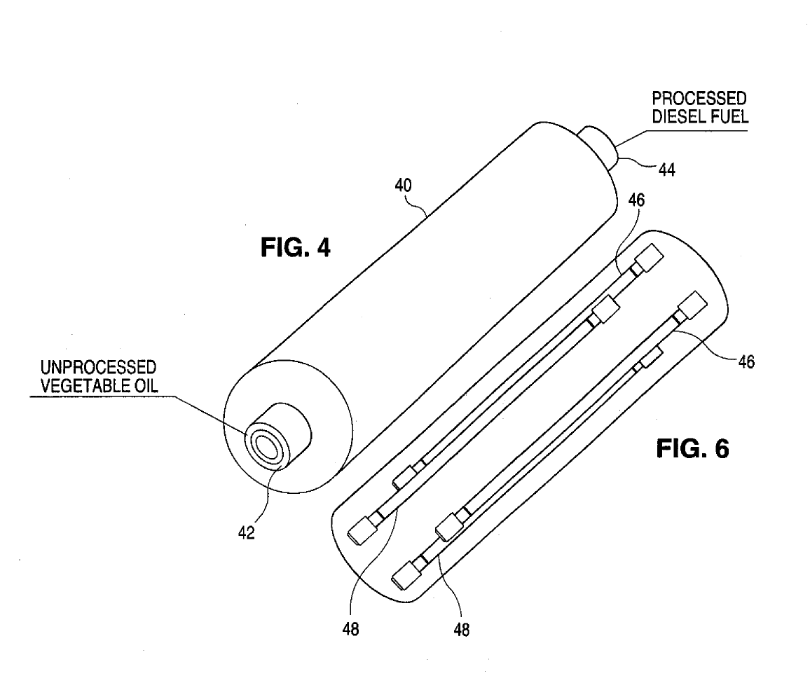

A further alternative is to provide multiple frequency sonic energy to the reactants in a tank through dual-frequency push-pull transducers located inside the tank and immersed in the reactants. This is illustrated in FIGS. 4-6. A cylindrical tank 40 has inlet and outlet couplings 42 and 44, respectively. Inside the tank 40 are two lower frequency push-pull transducers 46 and two higher frequency push-pull transducers 48. The ends of the transducers contain piezoelectric devices that vibrate at ultrasonic frequencies when driven with an alternating current driving signal. In one implementation of this embodiment, the lower frequency push-pull transducers 46 are 25 kHz and the higher frequency push-pull transducers 48 are 45 kHz, both of which are first harmonic frequencies.

Other alternatives are to use immersible transducers or probe transducers having two or more frequencies.

1. A processing apparatus comprising:
a process tank having one or more walls with external surfaces and having an inlet and an outlet, wherein the tank defines an interior for containing a reactant fluid to be processed; and
at least two groups of ultrasonic transducers coupled to the process tank, wherein each group of transducers has different harmonic frequencies, and wherein the groups of transducers are interspersed.

2. A processing apparatus as recited in claim 1, further comprising fluid reactants contained in the tank for a transesterification process to produce fatty-acid alkyl esters.

3. A processing apparatus as recited in claim 1, further comprising one or more ultrasonic generators for supplying driving signals to the ultrasonic transducers to cause the transducers to supply ultrasonic energy to fluid reactants in the tank.

4. A processing apparatus as recited in claim 1, wherein the tank has the shape of a five-sided prism with five rectangular side walls and two end walls.

5. A processing apparatus as recited in claim 1, wherein the tank has the shape of a cylinder with cylindrical side walls and two end walls.

6. A processing apparatus as recited in claim 1, wherein the transducers are coupled to the process tank by attachment to the external surfaces of the tank and wherein ultrasonic energy radiates from the transducers and through the walls to the reactant fluid inside the tank.

7. A processing apparatus as recited in claim 6, wherein the groups of transducers are uniformly interspersed on at least some of the walls of the tank.

8. A processing apparatus as recited in claim 6, wherein the tank includes rectangular side walls, and wherein the groups of transducers are arranged in multiple rows parallel to edges of the rectangular side walls.

9. A processing apparatus as recited in claim 6, wherein the transducers have a stacked construction with a piezoelectric layer between a head mass and a tail mass, and wherein the head mass is attached to the tank.

10. A processing apparatus as recited in claim 9, wherein the head mass is attached to the tank with an epoxy adhesive.

11. A processing apparatus as recited in claim 1, wherein the transducers are coupled to the process tank by placement in the interior of the tank.

12. A processing apparatus as recited in claim 11, wherein the transducers are push-pull transducers.

13. A processing apparatus as recited in claim 1, wherein a first group of transducers operates at a first harmonic frequency of the first group and a second group of transducers operates at a third harmonic frequency of the second group.

14. A processing apparatus as recited in claim 13, wherein the first harmonic frequency of the first group of transducers is about 58 kHz and wherein the third harmonic frequency of the second group of transducers is about 192 kHz.

15. A process for transesterizing vegetable oils or fatty acids into fatty-acid alkyl esters, the process comprising the steps of:
placing a reactant fluid including vegetable oils or fatty acids into a tank;
applying ultrasonic energy to the reactant fluid in the tank at two separate frequencies in the range of 15 kHz to 1.5 MHz.

16. A process as recited in claim 15, wherein the step of applying ultrasonic energy includes powering at least two groups of transducers, each group having a different harmonic frequency.

17. A process as recited in claim 16, wherein a first group of transducers operates at a first harmonic frequency of the first group and a second group of transducers operates at a third harmonic frequency of the second group.

18. A process as recited in claim 17, wherein the first harmonic frequency of the first group of transducers is about 58 kHz and wherein the third harmonic frequency of the second group of transducers is about 192 kHz.

19. A process as recited in claim 15, further including the steps of continuously supplying the reactant fluid to the tank and continuously removing reacted fluid from the tank.

20. A process as recited in claim 15, wherein the step of applying ultrasonic energy at two separate frequencies includes simultaneously applying the two frequencies.
